(19) United States
(12) Patent Application Publication
(10) Pub. No.: US 2024/0019519 A1
(43) Pub. Date: Jan. 18, 2024

(54) RF EMITTER CHARACTERIZATION SYSTEM

(71) Applicant: Applied Signals Intelligence, Inc., Stelring, VA (US)

(72) Inventors: John McCorkle, Vienna, VA (US); Timothy Miller, Arlington, VA (US)

(21) Appl. No.: 18/034,437

(22) PCT Filed: Oct. 26, 2021
(86) PCT No.: PCT/US2021/056596

§ 371 Date: Apr. 28, 2023

Related U.S. Application Data
(60) Provisional application No. 63/106,509, filed on Oct. 28, 2020.

(51) Int. Cl. G01S 3/46; H01Q 7/00; H01Q 21/24; G01S 3/74

(52) U.S. Cl. CPC G01S 3/46; H01Q 7/00; H01Q 21/24; G01S 3/74

(57) ABSTRACT

An RF source system and method including an antenna system receiving RF signals including radio signal waveforms communicated between a target device and a second device, the antenna system comprising at least one multiport antenna having a plurality of ports and having an associated antenna system manifold which provides complex output numbers representative of the set of complex voltages from the plurality of ports in the antenna system. The system also includes an RF receiver system configured to receive signals from the plurality of ports and a processing system programmed to determine a direction to the target device based on the received RF signals from the plurality of ports and the antenna system manifold.

### CROSS-REFERENCE TO RELATED APPLICATIONS

This application is related to U.S. Patent Application No. 63/106,509 filed Oct. 28, 2020, the contents of which are hereby incorporated into this application in their entirety. This application is related to U.S. patent application Ser. No. 17/038,600, filed Sep. 30, 2020, the contents of which are hereby incorporated into this application in their entirety. This application is also related to U.S. Pat. No. 9,279,880, issued Mar. 16, 2016, the contents of which are hereby incorporated into this application in their entirety.

### FIELD

The disclosed subject matter relates to radio frequency (RF) systems, such as radar, communications, direction finding (DF), multi-input multi-output (MIMO) radar and communication systems, RF metrology, and other applications where antenna arrays or beamforming antennas or antenna systems are used to characterize an RF source. The disclosed subject matter also relates to systems designed to detect and estimate the angle of arrival (AoA) or direction of arrival (DoA) of propagating waves such as electromagnetic waves and also characterize their polarization and also estimate the range to the emitter of a wave.

### BACKGROUND

A key problem of current DF systems is their large size, weight, power consumption, and setup time, when they must operate at low frequencies, such as a less than a few MHz.

Another problem for DF systems is the time required to compute the AoA for numerous signals of interest, such as the AoA of each packet from a large number of frequency hopping emitters. In this document the term “AoA” is used to mean either a single angle, such as azimuth, or a combination of angles, such as azimuth and elevation, in a defined coordinate system.

Given the extraordinarily wide frequency range and the associated wide range of patterns produced by the antenna across that range, and given how the patterns can be significantly modified by different installations, which must all be comprehended by the DF system's estimator system, it will be appreciated that there exists a standard “array manifold” definition that can capture the wide range of patterns, and be used to clearly explain embodiments of a DF estimator system (a) that embrace the dramatic pattern differences across the extraordinarily wide frequency range and span of installations, (b) that has processing gain to address the desire for a system that “operates with enough sensitivity to enable DF on small signals being listened to with nearby standard radio systems with larger antennas”, and (c) that “is able to estimate not only a signal's AoA, magnitude, and polarization, but also the AoA, magnitude, and polarization of a number of multipath terms associated with that signal”. It should be understood that an array manifold can represent an isolated array, or an “as installed” array.

An array manifold is an antenna array's transfer function versus AoA and polarization, including a transfer function for each of its ports. An array manifold is a five dimensional (5D) function or matrix that captures the complex output voltage (mag/phase phasor notation for a sine wave cos(2πft) where t=0 is at the center of the array), from the antenna's list of ports, when the antenna receives a standardized 1 V/m field strength electromagnetic (EM) wave, and its ports are terminated with a specified load resistance R_{L}. When expressed as a function, such as M (port, frequency, Az, El, polarization) (5 dimensions for the 5 arguments) the output is the complex output voltage from a given port resulting from an incoming signal with the given frequency, AoA, and polarization. When expressed as a matrix, the matrix as a whole captures the complex output voltages for (a) the array's list of ports, (b) a list of frequencies, a list of AoA (i.e. combinations of (c) azimuth and (d) elevation angles), and (e) two orthogonal polarizations (e.g. horizontal and vertical, or left and right hand circular). In this matrix case, the manifold might be expressed as the 5D matrix M_{i,f,k,n,pol} where the indexes i, f, k, n, pol (5 dimensions) correspond to (i) the port, (f) the frequency, (k) the azimuth, (n) the elevation, and (pol) the polarization. Interpolation between points in the matrix can be used to turn the matrix representation into a smooth functional representation.

It is often convenient to express the set of complex voltages from the set of antenna ports as a vector, at a given frequency, AoA (azimuth and elevation combo), and polarization. For example, a vector, v̅ (where the over-bar indicates the variable is a vector) could be defined where its terms are,

vᵢ=M_{i,f,k,n,0} 1

where the pol=0 indicates the vector is for vertical polarization, and where, for brevity, the f, k, n indexes are “understood” to ultimately take on particular values associated with the context of their use.

Similarly, the vector is sometimes made explicitly a function of the AoA, as in v̅(θₖ, ϕₙ), where its elements are,

vᵢ(θₖ,ϕₙ)=M_{i,f,k,n,0} 2

where, for brevity, the frequency is not explicitly shown but “understood” to take on a particular value associated with the context of its use.

The following references are incorporated by reference in their entirety.

Reference 1: Introduction into Theory of Direction Finding, 2011-2012 Rhode Schwarz catalog Radiomonitoring & Radiolocation.

Reference 2: Paul Denisowski, A comparison of radio direction-finding technologies, Rohde & Schwarz.

Reference 3: R&S ADDx Multichannel DF Antennas Product Overview, Version 4.00, September 2013.

Reference 4: W. Read, Review of Conventional Tactical Radio Direction Finding Systems, Communications Electronic Warfare Section, Electronic Warfare Division, Defence Research Establishment Ottawa, Technical Note 89-12, May 1989.

Reference 5: Sathish Chandran, Editor, Advances in Direction-of-Arrival Estimation, Artech House 2006, Norwood Mass. ISBN-10: 1-59693-004-7.

Reference 6. Lan-Mei Wang, Gui-Bao Wang, Cao Zeng, “MUTUAL COUPLING CALIBRATION FOR ELECTRO-MAGNETIC VECTOR SENSOR.” Progress In Electromagnetics Research B, Vol. 52, pp 347-362, 2013.

Reference 7: Oger M., Marie F., Lemur D., Le Bouter G., Erhel Y., Bertel L., “A method to calibrate HF receiving antenna arrays.” IEE Ionospheric Radio Techniques Symposium, London: United Kingdom (2006).

Reference 8: Cecconi, B., and P. Zarka (2005), “Direction finding and antenna calibration through analytical inversion of radio measurements performed using a system of two or three electric dipole antennas on a three-axis stabilized spacecraft.” Radio Sci., 40, RS3003, doi:10.1029/2004RS003070.

Reference 9: Baum, C. E., “Some Characteristics of Electric and Magnetic Dipole Antennas for Radiating Transient Pulses.” AFWL Sensors and Simulation Notes 125 (January 1971).

Reference 10: J. S. Yu, C-L James Chen, and C. E. Baum, “Multipole Radiations: Formulation and Evaluation for Small EMP Simulators.” Sensor and Simulation Notes 243 (July 1978).

Reference 11: E. G. Farr and J. Hofstra, “An Incident Field Sensor for EMP Measurements.” Electromagnetic Compatibility, IEEE Trans. on, May 1991, 105-13, Also published as Sensor and Simulation Notes 319 (July 1989).

Reference 12: Baum C. E., “General properties of antennas.” Electromagnetic Compatibility, IEEE Transactions on, vol. 44, no. 1, pp. 18-24, February 2002 doi: 10.1109/15.990707. Also Sensor and Simulation Notes 330 (July 1991);

Reference 13: F. M. Tesche, “The P×M Antenna and Applications to Radiated Field Testing of Electrical Systems, Part 1, Theory and Numerical Simulations.” Sensor and Simulation Notes 407 (July 1997).

Reference 14: F. M. Tesche, T. Karlsson, and S. Garmland, “The P×M Antenna and Applications to Radiated Field Testing of Electrical Systems, Part 2, Experimental Considerations.” Sensor and Simulation Notes 409 (July 1997).

Reference 15: E. G. Farr, C. E. Baum, W. D. Prather, and T. Tran, “A Two-Channel Balanced-Dipole Antenna (BDA) With Reversible Antenna Pattern Operating at 50 Ohms” Sensor and Simulation Notes 441 (December 1999).

Reference 16: McLean, J., H. Foltz, and R. Sutton. “Conditions for Direction-Independent Distortion in UWB Antennas.” Antennas and Propagation, IEEE Transactions on 54, no. 11 (November 2006): 3178-83. doi:10.1109/TAP.2006.883956.

Reference 17: Mayes, P. E., W. Warren, and F. Wiesenmeyer. “The Monopole Slot: A Small Broad-Band Unidirectional Antenna.” Antennas and Propagation, IEEE Transactions on 20, no. 4 (July 1972): 489-93. doi:10.1109/TAP.1972.1140250.

Reference 18. McLean, J., and R. Sutton. “Practical Realization of P×M Antennas for High-Power, Broadband Applications.” In Ultra-Wideband, Short-Pulse Electromagnetics 7, Chapter 30, edited by Frank Sabath, EricL. Mokole, Uwe Schenk, and Daniel Nitsch, 267-75. Springer New York, 2007.

Reference 19: McLean, J. S., and G. E. Crook. Broadband Antenna Incorporating Both Electric and Magnetic Dipole Radiators, U.S. Pat. No. 6,329,955.

Reference 20. McLean, J. S. P×M Antenna with Improved Radiation Characteristics over a Broad Frequency Range. U.S. Pat. No. 7,388,550 Jun. 17, 2008.

Reference 21: G. F. Brown, Direction finding antenna U.S. Pat. No. 8,179,328, 15 May 2012.

Reference 22: Schroeder, K., and K. Soo Hoo. “Electrically Small Complementary Pair (ESCP) with Interelement Coupling.” Antennas and Propagation, IEEE Transactions on 24, no. 4 (July 1976): 411-18. doi:10.1109/TAP.1976.1141376.

Reference 23: Mayes, P. E. Stripline Fed Hybrid Slot Antenna, U.S. Pat. No. 4,443,802 April 1984.

It would therefore be desirable to have a small multi-port antenna that prides the advantages described above. It would also be desirable to use such an antenna in conjunction with an antenna array to provide for rapid and accurate characterization of RF sources. It is this context that the need for the subject matter disclosed herein arises.

### SUMMARY

The following presents a concise summary of one or more embodiments in order to provide a basic understanding of the embodiments. This summary is not an extensive overview of all contemplated embodiments and is not intended to identify key or critical elements of all embodiments nor delineate the scope of any or all embodiments. Its sole purpose is to present some concepts of one or more embodiments in a simplified form as a prelude to the more detailed description that is presented later.

According to one aspect of an embodiment there is disclosed a system comprising an antenna system receiving RF signals including radio signal waveforms communicated between a target device and a second device, the antenna system comprising at least one multiport antenna having a plurality of ports adapted to receive the radio signal waveforms, and having an associated antenna system manifold which, given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization. The system also includes an RF receiver system configured to receive signals from the plurality of ports and for each port, produce the radio signal waveform communicated between the target device and the second device; and a processing system comprised of at least one computer processor programmed to determine a direction to the target device based on the received RF signals from the plurality of ports and the antenna system manifold, wherein the multiport antenna comprises two or more ports located at different locations, each port having a first terminal and a second terminal, and two or more conductive pieces, and wherein at least one pair of the conductive pieces connects through the first and second terminals of each of two or more ports.

The at least one computer processor may be adapted to generate a first set of complex feature values based on a correlation between the radio signal waveforms received by the plurality of ports, generate a second set of complex feature values based on the outputs of the plurality of ports as represented by the antenna system manifold, and determine that the direction to the target is the AoA that produces a second set of complex feature values closest to the first set of complex feature values. The at least one computer processor may be adapted to determine the AoA that produces a second set of complex feature values closest to the first set of complex feature values according to a Euclidean distance. The at least one computer processor programmed to locate or find the direction to the target based on the received waveforms from the plurality of ports may be adapted to generate a first set of complex feature values by correlating a first radio signal waveform received by a first port with a plurality of radio signal waveforms received by a plurality of other ports, and generate a set of feature values for each AoA in a of a set of AoA's of interest based on a complex weighted sum of a first complex weight applied to the outputs from the first port and the plurality of other ports represented by the antenna system manifold with an incoming first polarization signal, and a second complex weight that is applied to the outputs from the first port and the plurality of other ports represented by the antenna system manifold with an incoming second polarization signal, wherein the first and second complex weights at each AoA in the set of AoA's produce a second set of complex features that is closest to the first set of complex features according to a distance metric, and wherein the determined direction to the target is the AoA in the set of AoA's which produced the closest distance metric.

The target device may comprise an unmanned aerial system. The second device may comprise a remote control for the unmanned aerial system.

The processing system may be further programmed to characterize a type for the target device based on at least one of the target device's radio signal waveform, the target device's direction, and the target device's location. The system may further comprise a database of RF waveform data that the processing system accesses to characterize the type for the target device. The RF waveform data may comprise modulation information, and the database may comprise a modulation look-up table.

According to another aspect of an embodiment there is disclosed an apparatus comprising a memory and at least one processor operatively coupled to the memory, the at least one processor being configured to receive a radio frequency (RF) signature of at least one of an uplink and a downlink radio signal communicated between a target and a second device from an antenna system having at least one multiport antenna having a plurality of ports generating a respective plurality of signals and an associated antenna system manifold which, given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization; identify the radio frequency (RF) signature as being at least one of an uplink radio signal and a downlink radio signal; and determine a direction to the target based on the plurality of signals received from the plurality of ports, and the antenna system manifold, wherein the multiport antenna is comprised of two or more ports located at different locations and each having a first terminal and a second terminal, and two or more conductive pieces, and wherein at least one pair of the conductive pieces connect through the first and second terminals of each of two or more ports.

The processor may be configured to identify the target based on at least one of the RF signature of at least one of the uplink radio signal, the downlink radio signal, a direction to the target, and a location of the target. The apparatus may further comprise a database of RF signature data that the at least one processor accesses to identify the target. The RF signature data may comprise modulation information, and the database may comprise a modulation look-up table.

According to another aspect of an embodiment there is disclosed a method comprising detecting a radio frequency (RF) signature of at least one of an uplink and a downlink radio signal communicated between a target and a second device from an antenna system comprising at least one multiport antenna having a plurality of ports located at different locations respectively generating a plurality of signals, and having an associated antenna system manifold which, given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization, determining a direction to the target based on the plurality of signals received from the plurality of ports and the antenna system manifold, and identifying the target based on at least one of the RF signature and the direction. Identifying the target may comprise accessing a database of RF signature data. The RF signature data may comprise modulation information, and the database comprises a modulation look-up table.

According to another aspect of an embodiment there is disclosed an RF source characterization system comprising an antenna system including at least one multi-port antenna, the multiport antenna comprising at least two conductive pieces and a plurality of at least two ports, each port having a first terminal and a second terminal, wherein at least two of the plurality of ports have their terminals connected across a pair of conductive pieces at different locations, each of the ports being configured to simultaneously sense multiple incoming EM field components according to the AoA and polarization of the incoming wave, including both an H-field and an E-field component by sensing a voltage caused by E-field components (a) that induce a charge between the pair of conductive pieces, such as one piece being positive relative to the other at a time instant, and/or (b) that induce a charge across a conductive piece, such as one point on the conductive piece being positive relative to another point at a time instant, and simultaneously sensing currents flowing through loops oriented according to the port locations to flow through the pair of conductive pieces and pairs of ports, a loop for every combination of port pairing, the current in each loop being induced by the incoming H-field wherein the component of the H field that is oriented through the axis of each loop is sensed by the ports associated with that loop, such that each port simultaneously senses both an E-field induced charge and an H-field induced current, wherein the phase relationship between the voltage component and the current component can simultaneously produce, for a particular incoming AoA, a null or reduced output on one port and a relatively higher output on another port, such that different sets of port voltages can be associated with different angles of arrival, the antenna system being characterized by an antenna system manifold which, given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization, a receiving system arranged to receive the first signal and the second signal and being adapted to output a plurality of signals of interest, each signal of interest including of a set of outputs based on the first signal and the second signal, each signal of interest having an associated RF source, one of the RF sources being the RF source to be characterized, and an estimator system arranged to receive the plurality of signals of interest output by the receiving system, the estimator system being adapted to estimate at least one parameter related to each RF source by matching port voltages from the antenna system manifold to port voltages represented in the plurality of signals of interest.

The at least one parameter may include an angle-of-arrival of emissions from the RF source to be characterized and wherein the estimator system is adapted to estimate the angle-of-arrival by finding, for at least one signal of interest in the plurality of signals of interest, at least one angle in the array manifold that has port voltages most closely matching the port voltages represented in the signal of interest. The at least one parameter may include an angle-of-arrival of emissions from the RF source to be characterized and wherein the estimator system is adapted to estimate the angle-of-arrival by finding, for at least one signal of interest in the plurality of signals of interest, at least one angle in the array manifold that has port voltages most closely matching, according to a matching metric, the port voltages represented in the signal of interest. The matching metric may be a weighted least squares metric. The at least one parameter may include an estimated range and wherein the estimator system is adapted to estimate the estimated range based at least in part on finding, for each signal of interest in the plurality of signals of interest, a change in magnitude of the signal of interest caused by a change in a distance between the RF source characterization system and the RF source. The at least one parameter may be an estimated range and the estimator system may be adapted to estimate the estimated range based at least in part on changes in the estimated angle-of-arrival caused by a change in a direction between the RF source characterization system and the RF source. The antenna system may include ports that are balanced. At least one of the first port and the second port may comprise a coaxial structure. The antenna system may include ports that are unbalanced. The at least one signal of interest in the plurality of signals of interest includes two or more wavefronts arriving from different directions. The estimator system may be adapted to estimate parameters including angle-of-arrival, magnitude, and polarization, of the two or more wavefronts. The estimator system may be adapted to correct for noise induced estimation bias. The antenna system may include a multiport antenna with four ports and four conductive pieces configured such that the two current loops are nominally co-centered and orthogonal.

Further features and advantages of the present invention, as well as the structure and operation of various embodiments of the present invention, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the methods and systems of embodiments of the invention by way of example, and not by way of limitation. Together with the detailed description, the drawings further serve to explain the principles of and to enable a person skilled in the relevant art(s) to make and use the methods and systems presented herein. In the drawings, like reference numbers indicate identical or functionally similar elements.

FIG. 1 is a functional block diagram for an embodiment of a DF system, containing an antenna system, a receiver system, and an estimator system according to an aspect of an embodiment.

FIG. 2 is a functional block diagram of a DF system embodiment similar to the embodiment disclosed in connection with FIG. 1 but additionally including configuration and filtering parameters.

FIG. 3 is a functional block diagram illustrating an example arrangement for one of the channels in the multi-channel receiver system of FIG. 2 according to an aspect of an embodiment.

FIG. 4 is a functional block diagram illustrating an example arrangement for the estimator system of FIG. 2 according to an aspect of an embodiment.

FIG. 5 is a functional block diagram of a DF system embodiment similar to the embodiment disclosed in connection with FIG. 2 but additionally including a clustering system according to one aspect of an embodiment.

FIG. 6 is an embodiment of a multiport antenna with two ports and two flat tapered conductive pieces.

FIG. 7 is an embodiment of an antenna system comprised of two multiport antennas oriented in different directions, each with two ports and two flat tapered conductive pieces.

FIG. 8A and FIG. 8B are a plan and perspective view, respectively, of an embodiment of a multiport antenna according to an aspect of a disclosed embodiment.

FIG. 9 is a drawing depicting a specific application of the disclosed subject matter according to an aspect of an embodiment.

### DETAILED DESCRIPTION

This specification discloses one or more embodiments that incorporate the features of this invention. The disclosed embodiment(s) merely exemplify the present invention. The scope of the present invention is not limited to the disclosed embodiment(s). The present invention is defined by the claims appended hereto.

The embodiment(s) described, and references in the specification to “one embodiment,” “an embodiment,” “an example embodiment,” “an exemplary embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

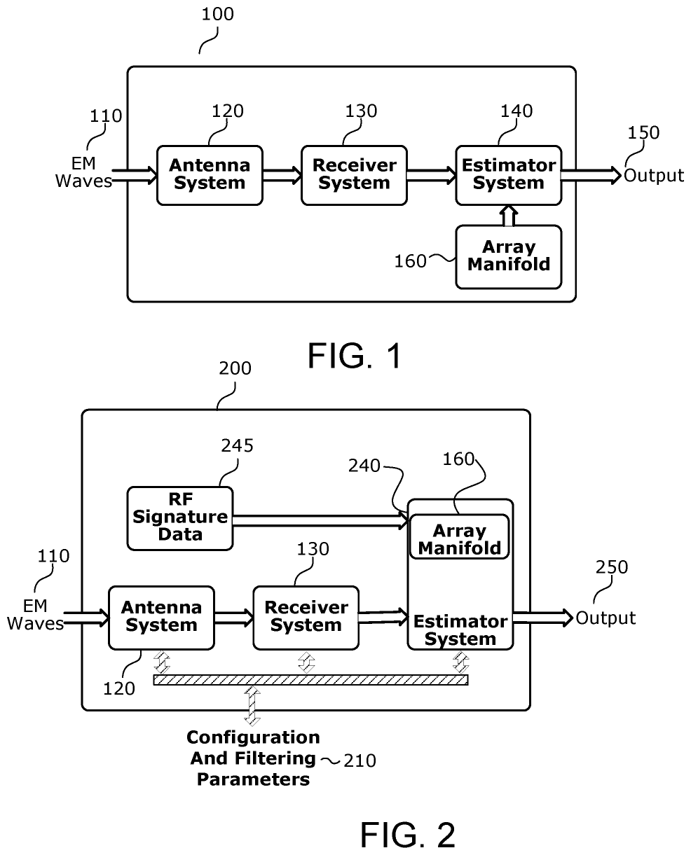

The disclosed subject matter relates RF characterization systems including multi-port antennas. Such an RF characterization system 100 is shown in FIG. 1. As depicted, the RF characterization system 100 includes an antenna system 120, a receiver system 130, and an estimator system 140. The estimator system 140 has access to an array manifold 160. It will be appreciated that these demarcations of elements is conceptual rather than physical, and these elements may be combined. For example, the estimator system 140 may have access to the array manifold 160 by virtue of the array manifold being part of the estimator system 140 as shown in FIG. 2.

FIG. 1 shows the signal flow through a DF system 500 according to an aspect of an embodiment. Electromagnetic (EM) waves 110 from various emitters arrive and are received by an antenna system 120. Antenna system 120 has characteristics captured in the array manifold 160 and, consistently with this manifold, converts the incoming EM wave 110 into a set of complex voltages, the set corresponding to the outputs of the ports in the antenna system 120. The receiver system 130 has a set of receive channels allowing it to accept the set of port voltages. The set of receive channels isolates and digitizes signals of potential interest (SoPI) and outputs a corresponding set of digitized SoPI. The set of digitized SoPI is accepted by the estimator system 140. The estimator system 140 has access to the array manifold 160 characterizing antenna system 120, and may also have knowledge of a set of phase and magnitude shifts that occur in the set of paths between the set of ports in antenna system 120 and the set of channels in receiver system 130, and uses this knowledge, along with the set of digitized SoPI, to estimate the AoA, and potentially other signal parameters, which estimate(s) it passes to output 150.

In terms of the isolation and characterization of an SoPI, or simply SoI, there may be two or more “parameter” lists. A first parameter list may be “SoI isolation parameters” comprising a list of criteria to isolate an SoI from other signals and noise. A second parameter list may be “signal parameters”, which are the parameters measured for SoI's from a given emission, or set of emissions, from an emitter, such as its center frequency, polarization, magnitude, bandwidth, AoA, range, SNR, modulation type, modulation parameters, time stamp, etc.

The SoI isolation parameters may specify that an SoI be within a center frequency range, bandwidth range, time duration range, etc., or have a hop-frequency set of parameters (hop duration range, rep-rate, single-packet bandwidth, total band, packet start/stop frequencies, etc., or that they come from a certain AoA range, or have a low variance after a number of looks. The SoI isolation parameters can be broken into different levels where each level is applied at different stages of processing.

At the highest level, there may be a receiver tuned to a band to cover all SoI's in that band (e.g. the entire HF band). This may be regarded as an initial limitation or “parameter” on defining an SoI space—the lowest and highest frequency of interest (where to tune the radio and what bandwidth filter to use). These might be considered “pre-banding” or “pre-JTFA” parameters, with JTFA being an acronym for joint time frequency analysis.

Given whatever receiver bandwidth (e.g. 40 MHz), it is then possible to look more narrowly (more precisely on SoI) such as 3 kHz bandwidth (BW) SSB signals at HF, versus 25 kHz BW narrow band FM (NBFM) signals at V/UHF, versus 200 kHz BW commercial FM, or 6 MHz BW TV, and 10 MHz bandwidth radar at 3 GHz. SoI isolation parameters such as these bandwidths of interest can be used to “aim” or precondition the JTFA processing to reduce processing load, in which case, they may be regarded as “pre-JTFA” parameters as well.

According to an aspect of an embodiment, JTFA may be used for this bandwidth refinement. JTFA detects time periods and frequency ranges where signals are located (or “pop up” or have high magnitude) in time and frequency. It is effectively equivalent to a parallel bank of filters of various bandwidths, wider bandwidth filters having finer time resolution, where the filter outputs, allow an analysis that can trading time resolution for frequency resolution to optimize detection, or measurement of start and stop times, or measurement of frequency content, etc.

An initial SoI (i.e. post-JTFA) is declared (detected) when a higher magnitude time span and bandwidth JTF zone is found on one or more of the plurality of ports, in which case, an SoI data record, containing, for at least two of the plurality of ports, a finite length record covering the particular time span and frequency span detected, is made for that SoI. Generation of this record constitutes initial SoI “detection”. The individual records associated with each of the plurality of ports, is then cross-correlated—each port with at least one among all the ports.

According to an aspect of an embodiment this use of JTFA detection and choosing of the length of the data record (in time or frequency) is performed using a CFAR (constant false alarm rate) detector, where the false alarm rate can be specified in the “SoI isolation parameters”. Other detectors could also be selected via the “SoI isolation parameters”.

All the SoI's detected can be output or they can be pruned and considered “preliminary”, that is, those SoI's passing the “post JTFA” or “pre-characterization” parameters' criteria. An SoI record may be time-stamped with absolute time (e.g. GPS time) or a number associated with timing, so that the “post-JTFA”, “pre-characterization”, and post-characterization SoI isolation parameters can include time metrics, durations, periodicity, etc. along with any measured “signal parameters”. “Pre-characterization” SoI's (i.e. those passing the criteria provided in the “SoI isolation parameters”) are sent on either to the output or for further processing, according to the “SoI isolation parameters”.

Generally, the number of SoPI's is reduced at each stage of processing. SoPI's are typically pruned when they do not sufficiently match the “parameter ranges” associated with being passed on from a given processing stage. SoPI's passing JTFA metrics like center frequency, bandwidth, time durations, and absolute time of occurrence are metrics that can be applied after JTFA processing.

Using direction finding as an example of characterization, “Post DF” or “pre-clustering” parameters would add, for example, that an SoI must be within a range of AoA's, or have certain polarization or magnitude properties, or have certain multipath properties. Note that finding the polarization and magnitude and multipath is part of the characterization process. AoA estimator system is configured to provide the measurements required by the SoI isolation parameters. For example, it might be configured to assume a known polarization signal or to estimate an unknown polarization signal, or to include or not include a number of multipath terms. SoI's passing the criteria as described by the “post-DF parameters” are sent on to output or for further processing, according to the “SoI isolation parameters”.

If the “SoI isolation parameters” include “post clustering” or “multi-look” parameters (i.e. the process is not finished after DF processing) then after DF processing, it is possible to output preliminary, not “final” but “next level” “pre-clustering”, SoI's. In this case, the system does not reduce to and output the “final” SoI's after the “multi-look” or “clustering” step.

The “post clustering” “multi-look” parameters include things such as, for example, that a set of hops from the emitter of a batch of SoI's are all within 10 degrees of one another, or that the SoI's from an emitter have a variance in AoA or magnitude below a certain threshold (potentially after outlier removal), or have a polarization that (a) remains within a certain variance (such as from a stationary antenna), or (b) goes beyond a certain variance (such as from a mobile radio's whip antenna moving around), or (c) is within an absolute range (e.g. 10 degrees from vertical), etc.

Any measured “signal parameters” for an SoI at any stage can be output (i.e. under the control of the criteria in the SoI isolation parameters). Again, as opposed to SoI isolation parameters, “signal parameters” are the parameters measured for SoI's from a given emission, or set of emissions, from an emitter, like its center frequency, polarization, magnitude, bandwidth, AoA, range, location, modulation type, modulation parameters, time stamp, etc.

As indicated elsewhere, the lines of demarcation of the system are arbitrary for explanation only. For example, a single physical component may carry out multiple functions. For example, the functions could be performed by one or more suitably programmed microprocessors.

FIG. 2 is a functional block diagram for an embodiment of an RF characterization system 200 similar to that shown in FIG. 1, but in which provision is made for each block to accept or communicate parameters 210. The blocks can communicate configuration and filtering parameters between themselves, or from an attached system, or both, allowing quick and easy customization, adaptability, and regression testing.

FIG. 2 shows the signal flow through RF characterization system 200. Electromagnetic (EM) waves 110 from various emitters arrive and are received by an antenna system 120. The antenna system 120 has characteristics captured in an array manifold 160 and, consistently with this manifold, converts the incoming EM wave 110 into a set of complex voltages, the set corresponding to the outputs of the ports in the antenna system 120. A receiver system 130 has a set of receive channels allowing it to accept the set of port voltages. The set of receive channels isolates and digitizes signals of potential interest (SoPI) and outputs a corresponding set of digitized SoPI. The set of digitized SoPI are accepted by an estimator system 240. The estimator system 240 has knowledge of the manifold characterizing the antenna system 120, and may also have knowledge of a set of phase and magnitude shifts that occur in the set of paths between the set of ports in the antenna system 120 and the set of channels in the receiver system 130, and uses this knowledge, along with the set of digitized SoPI, to estimate the AoA, and potentially other signal parameters, which estimate(s) it passes to output 250. Configuration and filtering parameters 210 can be used by at least one of: the antenna system 120, receiver system 130, and estimator system 240. The configuration and filtering parameters 210 may be communicated between 120, 130, and 240, or from an attached system, or both, allowing quick and easy customization, adaptability, and regression testing.

The RF characterization system 200 may be configured to identify a target based on at least one of the RF signature of at least one of the uplink radio signal, the downlink radio signal, a direction to the target, and a location of the target. The RF characterization system 200 may further comprise a database 245 of RF signature data that, for example, a processor accesses to identify the target. The RF signature data may comprise modulation information, and the database may comprise a modulation look-up table.

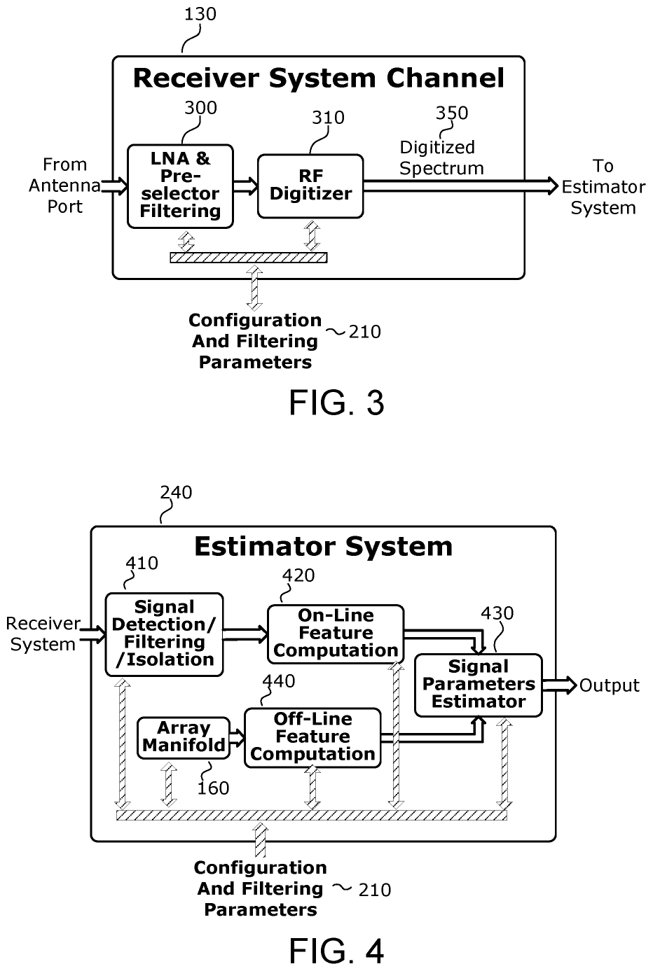

FIG. 3 shows a possible implementation of one of the receiver system channels in the multi-channel receiver system 200 shown in FIG. 2, being comprised of a low noise amplifier (LNA) and preselector filter 300 and an RF digitizer 310. The LNA and preselector filter 300 allows weak signals of potential interest at frequencies of interest to be isolated and captured by RF digitizer 310. RF digitizer 310 includes a digitizer (i.e. analog-to-digital converter), generally with a sampling clock that is tied to an absolute time, and mechanism that time stamps digitized records with an absolute time such as a GPS based time, and can include a frequency translation and filtering circuit at its input such as a tunable superheterodyne receiver prior to its digitizer, or a digital frequency filtering and translation process after its digitizer, such as a digital down converter, or both or neither. The configuration and filtering parameters 210 can include controls for LNA & preselector filter 300, such as tuning or selecting the frequency passbands and stopbands, and controlling the gain, including bypassing amplifiers to enhance the system's dynamic range for different RF environments. The parameters 210 can also include controls for RF Digitizer 310, such as the frequency translation prior to the digitizer, the digitizer sampling rate, and the frequency translation after the digitizer and any filtering and decimation applied to the output of the digitizer in order to further isolate SoPI from other signals in the output digitized spectrum 350. The output of 350 is a set of digitized spectrums corresponding to the set of port voltages from the antenna ports.

FIG. 4 shows a possible implementation of one of the estimator system channels in the estimator system 240 shown in FIG. 2. The set of signals coming from the receiver system 130 are accepted by Signal Detection/Filtering/Isolation block 410, which can be pre-programmed with default pre-estimation SoI defining parameters or can receive pre-estimation SoI defining parameters from the configuration and filtering parameters 210. Pre-estimation SoI defining parameters distinguish an SoPI from other extraneous signals and noise. As mentioned, pre-estimation SoI defining parameters can include a set of frequency-hop parameters, such as the hop frequency spacing, hop rate, highest and lowest frequency, on and off durations, etc. Pre-estimation SoI defining parameters can also include ranges for an SoI's frequency, average magnitude, standard deviation of its magnitude over a parameterized time period, peak magnitude, bandwidth, modulation type (which can include if it is pulsed, packetized, continuous AM, FM, nPSK, QAM, hopped, OFDM, etc.) and parameters associated with the detected modulation type, such as the time duration of its pulse, or its packets, or a duty cycle, a repetition rate, hop parameters, etc. Pre-estimation SoI defining parameters could also include rejection criteria, such as parameters for a priori known interfering signals and noise sources that should be ignored.

In one embodiment, Signal Detection/Filtering/Isolation block 410 is configured to perform a JTFA, typically comprised of a series of overlapping discrete Fourier transforms (DFT) and perform CFAR detection of signals matching the time durations and frequency ranges specified in the pre-estimation SoI defining parameters it receives from the configuration and filtering parameters 210. For signals passing the pre-estimation SoI defining parameters tests, Signal Detection/Filtering/Isolation block 410 outputs either (A) a set of filtered signal bursts covering the SoI's detected time duration or a parameter specified time duration carried by the configuration and filtering parameters 210, each SoI output as a data record with Nₛ time samples where each SoI can have a different Nₛ, or (B) a set of filtered signal bursts covering the SoI's detected bandwidth or a parameter specified bandwidth carried by the configuration and filtering parameters 210, each SoI output as a data record with Nₛ frequency samples, where each SoI can have a different Nₛ, where, for each SoI, the frequency domain output record in B is related to the time domain output record in A by a Fourier Transform. In either frequency or time domain cases, the Nₚ row matrix coming out of Signal Detection/Filtering/Isolation block 604a is associated with an SoPI having Nₛ samples, forming an Nₚ×Nₛ matrix.

That set of filtered signal bursts, which correspond to the set of port voltages, is accepted by On-Line Feature Computation block 420, which computes a feature vector for each SoPI burst that is output by Signal Detection/Filtering/Isolation block 410, and passes the computed feature vector to Signal Parameter Estimator block 430. The feature vector computation: (1) characterizes a received SoPI, which can contain a single wavefront or have multipath terms arriving from different angles of arrival, (2) is a fully phase coherent process that achieves high processing gain, (3) is agnostic to the phase of the incoming signal and only considers the differences in phase between the ports, and (4) reduces a record with many (Nₛ) samples down to a feature vector with a small number of real numbers. In a first configuration which eliminates estimator bias, where the features are found by cross-correlating one of the ports with the other ports, the feature vector has 2(Nₚ−1) real numbers. In a second configuration, where the features are found by cross-correlating each of the ports with all the ports, the feature vector has Nₚ² real numbers The cross-correlation is done over a relatively large number of sample points (e.g. many narrow time samples over a long time period or many narrow band frequency-domain samples over a wide bandwidth), resulting in high processing gain. For example, on an SSB signal with 3 kHz of bandwidth voice syllables or energy bursts last, on average, about 0.5 seconds or more. A 0.5 second SoPI output record would have around 5000 data points to capture the 3 kHz bandwidth.

Continuing with the SSB signal example, the feature computation block 420 compresses the 3 kHz bandwidth energy that is spread across the many (5000 per port) data points on its input, to an effective processed bandwidth of 2 Hz and a low number of points on its output. For example, using the second configuration, a 6-port antenna array would generate around 6×5000=30000 points which would be compressed to a feature vector with only 36 real numbers. Using the first configuration, a 7-port antenna array would generate around 7×5000=35000 points which would be compressed to a feature vector with only 12 real numbers. The ratio of 2 Hz to 3 kHz ratio shows that for this example, the feature calculation process delivers about 32 dB of processing gain on each port. So, a weak signal with 7 dB of SNR which is marginally intelligible, will have a post-processing SNR of 25 dB for the purposes of AoA estimation.

Off-Line Feature Computation block 440, using Array Manifold 160, either has precomputed, or computes, a set of matrixes needed by Signal Parameter Estimator 430, for each SoPI burst that is output by Signal Detection/Filtering/Isolation block 410. The matrixes needed by Signal Parameter Estimator 430 use the antenna system manifold to find, at the center frequency of each SoPI burst, the expected port outputs for a set of potential angles-of-arrival (azimuth and elevation) and for a set of (if the polarization of the incoming signal is also to be estimated) two different and preferably orthogonal polarizations (e.g. vertical and horizontal or right and left hand circular polarization) at each of the potential AoA's.

Signal Parameters Estimator 430 accepts the outputs from On-Line Feature Computation block 420, and Off-Line Feature Computation block 440, and uses a matching metric between the feature vector from On-Line Feature Computation block 420, and the matrixes from Off-Line Feature Computation block 440 to find a set of estimated signal parameters for each SoPI. In one embodiment, the estimated signal parameters include each SoPI's AoA, polarization parameters, magnitude, and if there are any associated multipath waves, how many there are, and their AoA, magnitude, phase, and polarization parameters. The polarization parameters are generally output as a Jones vector but may also be output a Stokes vector or other representations. Available for output are both the newly estimated signal parameters and the previously measured metrics allowing the signal to pass the pre-estimation SoI defining parameters tests. Also available are the time stamps applied to the SoPI bursts that generated the estimated signal parameters. Post-estimation SoI defining parameters could include ranges for one or more of the estimated signal parameters, such as ranges of angles of arrival to ignore or output, or polarizations to ignore or output. Either predefined/default post-estimation SoI defining parameters are used, or they are accepted from the configuration and filtering parameters 210. Only those signal parameters requested by the configuration and filtering parameters, and only for SoI meeting the SoI defining parameters are output from Signal Parameter Estimator 430, and thus RF characterization system 240.

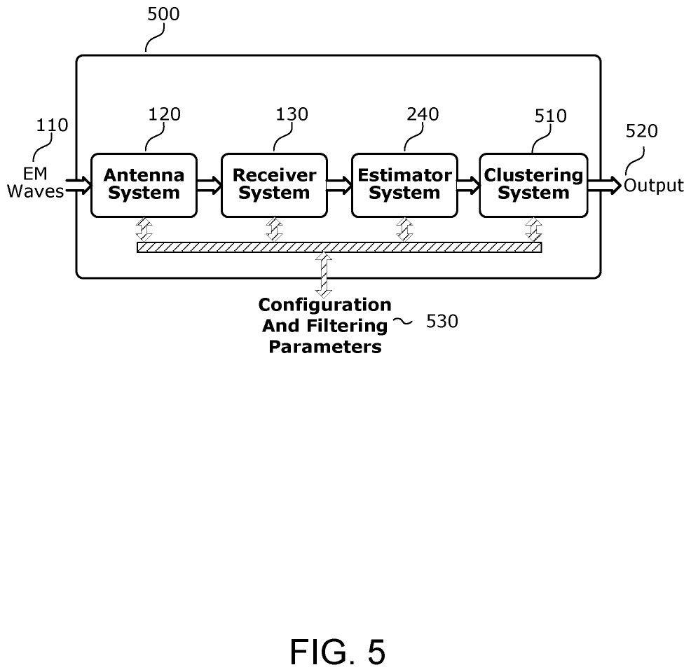

The embodiment depicted in FIG. 5 is similar to that depicted in FIG. 4 but the RF characterization system 500 of FIG. 5 additional includes a clustering system 510. The clustering system 500 accepts a series of signal parameters, including such items as AoA, magnitude, polarization, frequency, modulation type, time stamp (or number associated with timing) and other metrics measured so as to pass the various stages or levels of SoI defining parameters. The clustering system 500 can derive an emitter's velocity and range by fitting a curve to an SoI's magnitude's rate of change and acceleration over time. Because the clustering system 500 has multiple looks at an emitter, the clustering can improve the AoA estimation accuracy and reliability in that it can discard outliers and perform averaging. Having a priori knowledge of likelihoods that the SoI will be within a certain range of angles of arrival and likelihood that it is not in other ranges of AoA would also allow improved AoA estimation performance. The clustering system 500 can group (or cluster) signals with a common AoA, or common AoA and polarization, allowing the clustering system 500 to isolate different emitters using the same frequency band, and allowing it to group and identify frequency hop sets used by different frequency hopping emitters, simplifying characterization and demodulation of hopping signals sent by a particular emitter.

The clustering system 510 also allows classification of emitters, such as moving versus stationary, by features such as how its polarization changes over time such as its randomness or its periodicity spectrum and the angular range over which it rotates. Configuration and filtering parameters 530 add additional parameters to those in configuration and filtering parameters 210. The additional parameters configure the clustering system 510 to optimize its performance under different operating scenarios. Configuration and filtering parameters 530 include such things as the number of estimates (or duration of time) the clustering system 510 should use to perform its clustering functions. Configuration and filtering parameters 530 can also include apriori probabilities that the SoI will be within a certain range of angles of arrival and probabilities that the SoI will not be in other ranges of AoA. Clustering system 510 can also use configuration and filtering parameters 530 to further isolate SoI from SoPI by filtering based on the addition parameters it generates. For example, parameters 530 may specify to only pass emitters that are stationary, or only those that are moving, or only pass those that are frequency hopping emitters, or pass all frequency hopping emitters that do not use a certain set of hop frequencies, or a certain frequency hop sequence, or a certain set of hoping frequency parameters.

In some embodiments, the estimator system generates an estimated AoA by finding, for a set of signals of interest, the angles in the array manifold that would produce port voltages most closely matching, according to a matching metric, those from each signal of interest (SoI). Different embodiments use different matching metrics and or different signal models to optimize the AoA estimation accuracy. For example, an embodiment may model the signal as being a single wavefront (i.e. a signal with no multipath) with a priori known polarization. When the polarization matches the model, and the signal actually has no accompanying multipath, this embodiment is capable of giving superior estimates. Some embodiments may model the signal as having multipath, where the polarizations of all terms are unknown and are estimated as part of the AoA estimation optimization process. This model may often the best performing model for some applications because, for example, (1) handheld radios and mobile radios are not held to be vertical or horizontal, but sway, and (2) signals almost always have a ground bounce reflection, and if the ground is tilted, or if the reflection is from a dihedral formed by random angle boulder edges or the edge formed by a tree or building and tilted ground, the polarization will be rotated.

Besides signal models, matching metrics optimize different measures such as minimizing the mean square error (MMSE) (least squares) (Euclidean), minimizing the maximum error (mini-max), finding what is most likely (maximum likelihood), and other error minimization norms like H-infinity norm. Neural net based approaches aim to achieve similar combinations of high accuracy and robust performance in a wide variety of situations. Embodiments using a neural network require training with a large number of Monte Carlo noise instantiations added to all AoA and polarization combinations for all possible combinations of multipath terms, for every frequency in the array manifold, and preferably, lots of measured data with accompanying high accuracy truth data. While neural net based approaches require a lot of training data and compute time, once trained, they may be able to run with low latency on processors suitably small for portable systems.

Besides the signal model and the different measures for what is being optimized, the matching performance is affected by biases in the estimation process. The estimator system may be capable of jointly estimating the bias along with the AoA, mag/phase, and polarization of an incoming signal, and as such, minimizing its impact.

The above operations and all operations described herein can be carried out by one or more components of digital electronic circuitry, computer hardware, firmware, and software, for example, a suitable programmed processor or set of processors and associated memory which can include read-only memory and/or random access memory. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks.

Implementations may also include one or more programmable processors, and one or more computer program products tangibly embodied in a machine-readable storage device for execution by one or more programmable processors. The one or more programmable processors can each execute a program of instructions to perform desired functions by operating on input data and generating appropriate output. Generally, the processors receive instructions and data from the memory. Any of the foregoing may be supplemented by, or incorporated in, specially designed ASICs (application-specific integrated circuits). These components may be physically centralized or be partially or wholly distributed throughout the embodiment.

The above-described arrangements derive particular advantages from the use as an antenna system 120 of antennae as described in U.S. Pat. No. 9,279,880 and U.S. Patent application No. U.S. patent application Ser. No. 17/038,600, both incorporated by reference above. These antennae may be balanced or unbalanced. These antennae may or may not include a reference port.

According to an aspect of an embodiment, the two or more port multiport antenna is comprised of two or more conductive pieces with two or more ports physically distributed around the two or more conductive pieces, each port having two terminals, a first terminal and a second terminal, wherein each port's first terminal is connected to one conductive piece, and each port's second terminal is connected to a different conductive piece, and at least two of the ports form current loops through each other via their connection to the two or more conductive pieces.

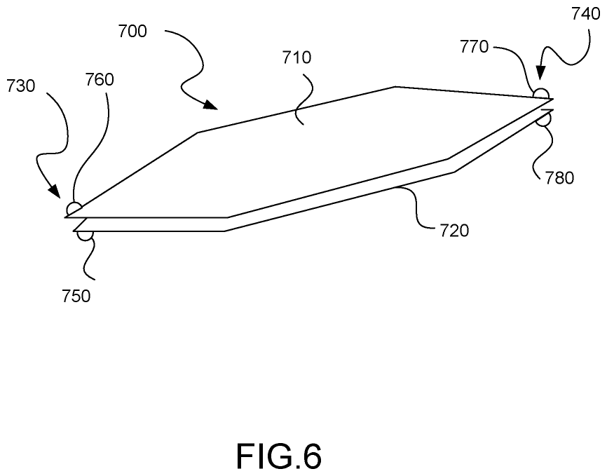

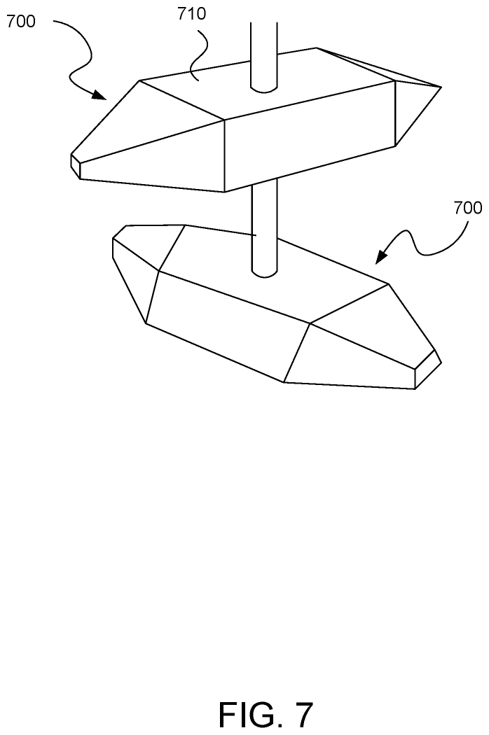

FIG. 6 shows the antenna element 700 in a balanced configuration. The antenna element 700 can be described as a pair of conductive surfaces 710 and 720 offset from one another with a pair of ports, first port 730 and second port 740, where each port is formed by a connection to the two conductive surfaces 710 and 720 such that a loop is formed going from a first terminal 750 of the first port 730, through the first conductive surface 710 to the first terminal 770 of the second port 740, through the second port 740 to the second terminal 790 of the second port 740, and through the second conductive surface 720 to the second terminal 760 of the first port 730, and through the first port 730 back to the first terminal 750 of the first port 739 to complete the loop. The construction has the property that the H-field sensing current loops have current flowing through the same shared conductive pieces and across the terminals of the same set of physically distributed ports, that are sensing E-fields, which are inducing different charges across those same ports. That all the ports contain both an E and H field component allow the ports to have well-defined patterns that are useful for direction finding at extremely low frequencies where the antenna is extremely electrically small. FIG. 7 shows two antenna elements 700 oriented as a crossed pair.

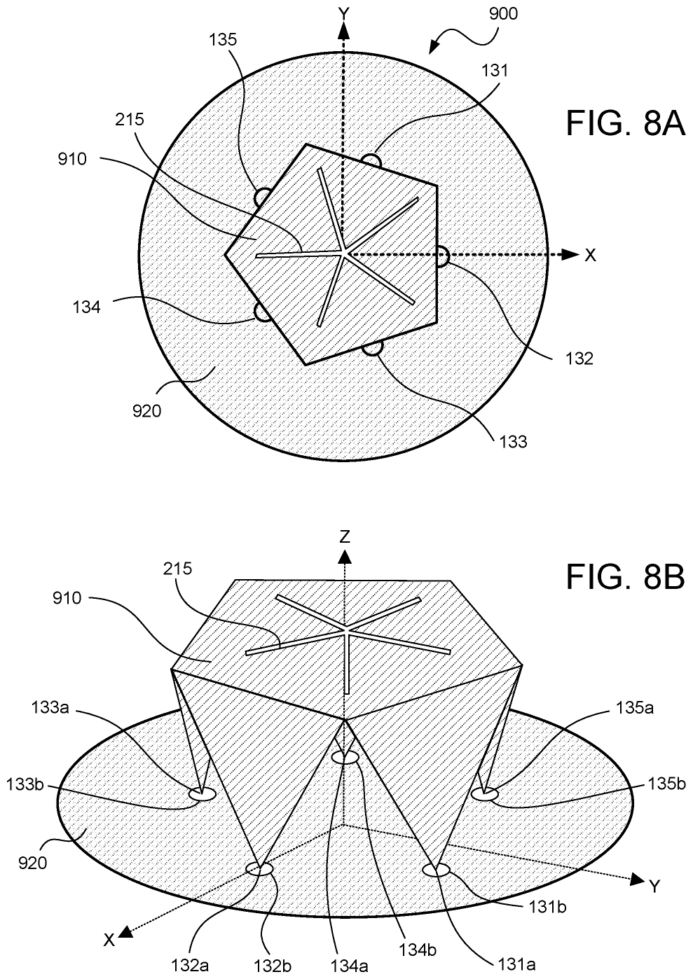

FIGS. 8A and 8B illustrate, using a top and perspective view, respectively, an embodiment of a multiport antenna 900 with two conductive pieces and five ports, each port having a first and a second terminal, where the first terminal of all five ports connects to a first conductive piece, and where the second terminal of all five ports connects to a second conductive piece, and where the ports are physically distributed.

More specifically, FIGS. 8A and 8B illustrate an embodiment of a multiport antenna 900 with two conductive pieces, a first conductive piece 910 and a second conductive piece 120, and five ports 131, 132, 133, 134, and 135. Each port has a first and a second terminal. The perspective view shown in FIG. 8B labels the first terminal of each of the ports with the letter “a”, as in terminal 131a, 132a, 133a, 134a, and 135a, which all are electrically connected to first conductive piece 910. The second terminal of each of the ports, terminals 131b, 132b, 133b, 134b, and 135b, is electrically connected to the second conductive piece 920. As such, the first terminal of all five ports connects to the first conductive piece 910, the second terminal of all five ports connects to the second conductive piece 920, and the ports are physically distributed. The illustrated arrangement allows either a balun or a coaxial cable or other type of coaxial connector or terminator to be connected to a port.

The ports themselves are coaxial in the sense that they include a center conductor, for example, the tip of the triangular piece, and a surrounding structure, for example, the hole. The coaxial port configuration as just described allows every port to have a direct wide-band connection without any band limiting, or reliability limiting, or weight adding component such as a balun. Moreover, it allows the antenna to made easily configurable since a port can attach to a coaxial switch that can be configured to select between different terminations, such as a short, open, or a specific impedance, or select between bypassing or using an amplifier, or select between different filters in a filter bank. Of course, it will be apparent to one having ordinary skill in the art that other arrangements may be used.

Also as show in in FIGS. 8A and 8B, in some embodiments the antenna 900 may have an overall box-like shape with one of the conductive pieces being substantially planar and the other conductive piece having a substantially planar portion spaced away from and substantially parallel to the substantially planar conductive piece. Here ‘substantially planar” and “substantially parallel” ‘means sufficiently close to planar or parallel that electrical performance is not unduly affected.

The construction also allows all ports to be physically constructed in a coaxial configuration where the shields of the coaxial ports all connect to a common metal piece, allowing every port to have a direct wide-band connection without any band limiting, or reliability limiting, or weight adding component such as a balun. Moreover, the coaxial port configuration allows the antenna to be easily configurable since a port can attach to a coaxial switch that can be configured to select between different terminations, such as a short, open, or a specific impedance, or select between bypassing or using an amplifier, or select between different filters in a filter bank. It also allows extremely low system noise figures at high frequencies because a low noise amplifier can be connected to the coaxial port, effectively, with no lossy cable.

As described above, a coaxial port configuration facilitates the antenna system being made configurable because a port can attach to a coaxial switch that can be configured to select between different terminations, such as a short, open, specific impedance, or specific length of transmission line, or select between bypassing or using an amplifier, or select between different filters in a filter bank. Each configuration would require an associated array manifold. Similarly, since the array manifold 160 is affected by the port terminations, and receiver system 130 may have configurations that present different termination impedances to the antenna, configuration and filtering parameters 210 can be used to communicate a manifold to estimator system 240 that is associated with the configuration and filtering parameters 210 accepted by receiver system 130. Communication of the manifold via configuration and filtering parameters 210 allows the same system hardware to be easily and quickly used in different installations. In this case, the estimator system 240 would accept as part of the configuration and filtering parameters 210 or 530, an “as installed” array manifold for that particular installation.

These are merely examples of antenna elements that may be incorporated into the RF emitter characterizers described herein. Other suitable antenna elements may be found in U.S. Pat. No. 9,279,880 and U.S. Patent application No. U.S. patent application Ser. No. 17/038,600.

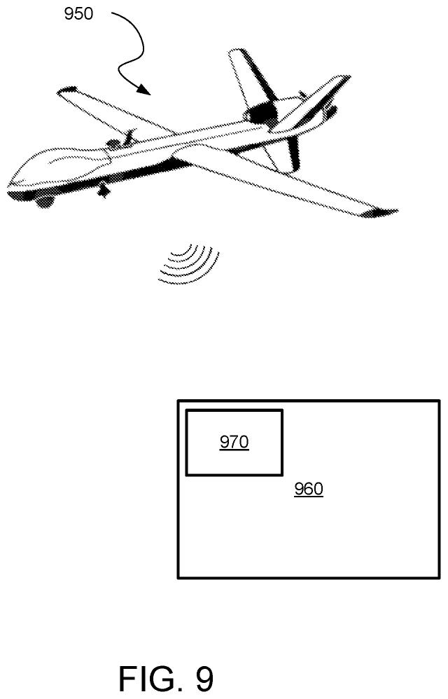

FIG. 9 shows implementation of the RF characterizing system 970 such as disclosed above where the RF source or target device is a UAS 950 and the RF characterizing system 970 is incorporated into a controller 960 for the UAS 950.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A system comprising:
an antenna system receiving RF signals including radio signal waveforms communicated between a target device and a second device, the antenna system comprising at least one multiport antenna having a plurality of ports adapted to receive the radio signal waveforms, and having an associated antenna system manifold which,
given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and
given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization;
an RF receiver system configured to receive signals from the plurality of ports and for each port, produce the radio signal waveform communicated between the target device and the second device; and
a processing system comprised of at least one computer processor programmed to determine a direction to the target device based on the received RF signals from the plurality of ports and the antenna system manifold,
wherein the multiport antenna comprises two or more ports located at different locations, each port having a first terminal and a second terminal, and two or more conductive pieces, and
wherein at least one pair of the conductive pieces connects through the first and second terminals of each of two or more ports.

2. The system of claim 1, wherein the at least one computer processor programmed to locate or find the direction to the target based on the received waveforms from the plurality of ports, is adapted to
generate a first set of complex feature values based on a correlation between the radio signal waveforms received by the plurality of ports,
generate a second set of complex feature values based on the outputs of the plurality of ports as represented by the antenna system manifold, and
determine that the direction to the target is the AoA that produces a second set of complex feature values closest to the first set of complex feature values.

3. The system of claim 2 wherein the at least one computer processor is adapted to determine the AoA that produces a second set of complex feature values closest to the first set of complex feature values according to a Euclidean distance.

4. The system of claim 1, wherein the at least one computer processor programmed to locate or find the direction to the target based on the received waveforms from the plurality of ports, is adapted to
generate a first set of complex feature values by correlating a first radio signal waveform received by a first port with a plurality of radio signal waveforms received by a plurality of other ports, and
generate a set of feature values for each AoA in a of a set of AoA's of interest based on a complex weighted sum of,
a first complex weight applied to the outputs from the first port and the plurality of other ports represented by the antenna system manifold with an incoming first polarization signal, and
a second complex weight that is applied to the outputs from the first port and the plurality of other ports represented by the antenna system manifold with an incoming second polarization signal,
wherein the first and second complex weights at each AoA in the set of AoA's produce a second set of complex features that is closest to the first set of complex features according to a distance metric, and
wherein the determined direction to the target is the AoA in the set of AoA's which produced the closest distance metric.

5. The system of claim 1 wherein the target device comprises an unmanned aerial system.

6. The system of claim 5 wherein the second device comprises a remote control for the unmanned aerial system.

7. The system of claim 1 wherein the processing system is further programmed to characterize a type for the target device based on at least one of the target device's radio signal waveform, the target device's direction, and the target device's location.

8. The system recited in claim 7, further comprising a database of RF waveform data that the processing system accesses to characterize the type for the target device.

9. The system recited in claim 8, wherein the RF waveform data comprises modulation information, and the database comprises a modulation look-up table.

10. An apparatus, comprising:
a memory; and
at least one processor operatively coupled to the memory, the at least one processor being configured to:
receive a radio frequency (RF) signature of at least one of an uplink and a downlink radio signal communicated between a target and a second device from an antenna system having at least one multiport antenna having a plurality of ports generating a respective plurality of signals and an associated antenna system manifold which,
given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and
given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization;
identify the radio frequency (RF) signature as being at least one of an uplink radio signal and a downlink radio signal; and
determine a direction to the target based on the plurality of signals received from the plurality of ports, and the antenna system manifold,
wherein the multiport antenna is comprised of two or more ports located at different locations and each having a first terminal and a second terminal, and two or more conductive pieces, and
wherein at least one pair of the conductive pieces connect through the first and second terminals of each of two or more ports.

11. The apparatus of claim 10 wherein the processor being configured to identify the target based on at least one of the RF signature of at least one of the uplink radio signal, the downlink radio signal, a direction to the target, and a location of the target.

12. The apparatus of claim 11, further comprising a database of RF signature data that the at least one processor accesses to identify the target.

13. The apparatus of claim 11 wherein the RF signature data comprises modulation information, and the database comprises a modulation look-up table.

14. A method, comprising:
detecting a radio frequency (RF) signature of at least one of an uplink and a downlink radio signal communicated between a target and a second device from an antenna system comprising at least one multiport antenna having a plurality of ports located at different locations respectively generating a plurality of signals, and having an associated antenna system manifold which,
given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and
given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization;
determining a direction to the target based on the plurality of signals received from the plurality of ports and the antenna system manifold; and
identifying the target based on at least one of the RF signature and the direction.

15. The method recited of claim 14, wherein identifying the target comprises accessing a database of RF signature data.

16. The method of claim 15 wherein the RF signature data comprises modulation information, and the database comprises a modulation look-up table.

17. An RF source characterization system comprising:
an antenna system including at least one multi-port antenna, the multiport antenna comprising at least two conductive pieces and a plurality of at least two ports, each port having a first terminal and a second terminal, wherein at least two of the plurality of ports have their terminals connected across a pair of conductive pieces at different locations, each of the ports being configured to simultaneously sense multiple incoming EM field components according to the AoA and polarization of the incoming wave, including both an H-field and an E-field component by
sensing a voltage caused by E-field components (a) that induce a charge between the pair of conductive pieces, such as one piece being positive relative to the other at a time instant, and/or (b) that induce a charge across a conductive piece, such as one point on the conductive piece being positive relative to another point at a time instant, and
simultaneously sensing currents flowing through loops oriented according to the port locations to flow through the pair of conductive pieces and pairs of ports, a loop for every combination of port pairing, the current in each loop being induced by the incoming H-field wherein the component of the H field that is oriented through the axis of each loop is sensed by the ports associated with that loop,
such that each port simultaneously senses both an E-field induced charge and an H-field induced current,
wherein the phase relationship between the voltage component and the current component can simultaneously produce, for a particular incoming AoA, a null or reduced output on one port and a relatively higher output on another port, such that different sets of port voltages can be associated with different angles of arrival,
the antenna system being characterized by an antenna system manifold which,
given a prescribed center frequency, incidence angle, and first polarization, provides a first set of complex output numbers representative of the set of complex voltages from the plurality of ports in the antenna system given an incoming waveform at the prescribed center frequency, incidence angle, and first polarization, and
given a prescribed center frequency, incidence angle, and second polarization different from or orthogonal to the first polarization, provides a second set of complex output numbers representative of the set of voltages from the plurality of ports in the antenna system given an incoming waveform at the prescribed center frequency, incidence angle, and second polarization
a receiving system arranged to receive the first signal and the second signal and being adapted to output a plurality of signals of interest, each signal of interest including of a set of outputs based on the first signal and the second signal, each signal of interest having an associated RF source, one of the RF sources being the RF source to be characterized; and
an estimator system arranged to receive the plurality of signals of interest output by the receiving system, the estimator system being adapted to estimate at least one parameter related to each RF source by matching port voltages from the antenna system manifold to port voltages represented in the plurality of signals of interest.

18. An RF source characterization system as claimed in claim 17 wherein the at least one parameter includes an angle-of-arrival of emissions from the RF source to be characterized and wherein the estimator system is adapted to estimate the angle-of-arrival by finding, for at least one signal of interest in the plurality of signals of interest, at least one angle in the array manifold that has port voltages most closely matching the port voltages represented in the signal of interest.

19. An RF source characterization system as claimed in claim 18 wherein the at least one parameter includes an angle-of-arrival of emissions from the RF source to be characterized and wherein the estimator system is adapted to estimate the angle-of-arrival by finding, for at least one signal of interest in the plurality of signals of interest, at least one angle in the array manifold that has port voltages most closely matching, according to a matching metric, the port voltages represented in the signal of interest.

20. An RF source characterization system as claimed in claim 19 wherein the matching metric is a weighted least squares metric.

21. An RF source characterization system as claimed in claim 18 wherein the at least one parameter also includes an estimated range and wherein the estimator system is adapted to estimate the estimated range based at least in part on finding, for each signal of interest in the plurality of signals of interest, a change in magnitude of the signal of interest caused by a change in a distance between the RF source characterization system and the RF source.

22. An RF source characterization system as claimed in claim 17 wherein the at least one parameter is an estimated range and wherein the estimator system is adapted to estimate the estimated range based at least in part on changes in the estimated angle-of-arrival caused by a change in a direction between the RF source characterization system and the RF source.

23. An RF source characterization system as claimed in claim 17 wherein the antenna system includes ports that are balanced.

24. An RF source characterization system as claimed in claim 23 wherein at least one of the first port and the second port comprises a coaxial structure.

25. An RF source characterization system as claimed in claim 17 wherein the antenna system includes ports that are unbalanced.

26. An RF source characterization system as claimed in claim 17 wherein at least one signal of interest in the plurality of signals of interest includes two or more wavefronts arriving from different directions.

27. An RF source characterization system as claimed in claim 17 wherein the estimator system is adapted to estimate parameters including angle-of-arrival, magnitude, and polarization, of the two or more wavefronts.

28. An RF source characterization system as claimed in claim 17 wherein the estimator system is adapted to correct for noise induced estimation bias.

29. An RF source characterization system as claimed in claim 17 wherein the antenna system includes a multiport antenna with four ports and four conductive pieces configured such that the two current loops are nominally co-centered and orthogonal.
